(19) United States
(12) Patent Application Publication
(10) Pub. No.: US 2026/0094447 A1
(43) Pub. Date: Apr. 2, 2026

(54) ROAD SITUATION DETECTION DEVICE AND METHOD FOR DETERMINING ABNORMAL SITUATION

(71) Applicant: SK Planet Co., Ltd., Seongnam-si (KR)

(72) Inventors: U Ju GIM, Sejong-si (KR); Joon Sung LEE, Seoul (KR); Chi Yurl YOON, Seoul (KR)

(21) Appl. No.: 19/411,053

(22) Filed: Dec. 5, 2025

Related U.S. Application Data
(62) Division of application No. 18/951,657, filed on Nov. 19, 2024.

(30) Foreign Application Priority Data
Nov. 24, 2023 (KR) 10-2023-0165679
Nov. 29, 2023 (KR) 10-2023-0169563
Dec. 8, 2023 (KR) 10-2023-0178090
Dec. 8, 2023 (KR) 10-2023-0178092

(51) Int. Cl. G06V 20/52; G06V 10/56; G06V 10/60; G06V 10/82

(52) U.S. Cl. CPC G06V 20/52; G06V 10/56; G06V 10/60; G06V 10/82; G06V 2201/08

(57) ABSTRACT

The present disclosure relates to a technology for determining abnormal situations (e.g., wrong-way driving) regarding the driving of a vehicle object through object recognition from a captured image, and realizes a technical configurations and embodiments for determining, with high reliability, abnormal situations (e.g., wrong-way driving) regarding the driving of a vehicle object in a roadway from a captured image.

### CROSS-REFERENCE TO RELATED APPLICATIONS

This is a divisional of U.S. patent application Ser. No. 18/951,657, filed on Nov. 19, 2024, which claims to Korean Patent Application No. 10-2023-0178092, filed on Dec. 8, 2023, Korean Patent Application No. 10-2023-0178090, filed on Dec. 8, 2023, Korean Patent Application No. 10-2023-0165679, filed on Nov. 24, 2023, and Korean Patent Application No. 10-2023-0169563, filed on Nov. 29, 2023, which are incorporated by reference herein in their entirety.

### BACKGROUND

### Field of the Invention

The present disclosure relates to a technology for determining anormal situations regarding the driving of a vehicle object through object recognition from a captured image.

### Description of the Prior Art

Due to the rapid increase in the number of vehicles in recent years, there is an increasing number of major vehicle accidents on the roads. In particular, vehicle wrong-way driving situations are one of main factors that cause major accidents, alongside icy road accidents.

These wrong-way driving accidents mostly occur during late-night hours when there is low traffic flow and visibility is limited, and the wrong-way driving accidents are highly likely to result in casualties.

Therefore, in order to prevent major accidents caused by wrong-way driving of vehicles, it is necessary to seek an efficient method for more accurately detecting wrong-way driving situations of vehicles on the road.

### SUMMARY

The problem to be solved in the present disclosure is to provide a technology for determining abnormal situations (e.g., wrong-way driving) regarding the driving of a vehicle object through object recognition from a captured image, and to realize a technical method for determining, with high reliability, abnormal situations (e.g., wrong-way driving) regarding the driving of a vehicle object in a roadway from a captured image.

A road situation detection device according to an embodiment of the present disclosure includes: a memory including instructions; and a processor configured to, by executing the instructions, determine a roadway in a captured image through region distinguishing in a captured image, and determine an abnormal situation regarding driving of a vehicle object in the roadway in the captured image.

The processor may be configured to distinguish between a driving road region and a non-driving road region in the captured image, based on a pretrained region distinguishing model, and determine that the distinguished driving road region is the roadway.

The region distinguishing model may be a deep learning model that is defined to distinguish between a driving road region, in which a vehicle travels, and a non-driving road region, in which a non-vehicle moving object moves, by being trained on training data based on a movement speed and a movement trajectory of an unspecified moving object identified in a captured image, based on multiple images captured under shooting conditions identical to those of the captured image, and wherein from the training data, relevant data of a specific moving object that is capable of moving on both a roadway and a sidewalk are excluded.

The specific moving object may be configured as a moving object for which an audio waveform of a specific tire friction sound, which specifies an electric scooter and a bicycle from among unspecified moving objects identified in each of the multiple captured images, is detected based on tire friction sound data acquired at time points when the multiple captured images are taken at a location of a device configured to take the captured image.

The abnormal situation may be determined in case that a driving direction of a vehicle object recognized on the roadway in the captured image is recognized to be opposite or different from a driving direction of the roadway, or in case that the vehicle object recognized on the roadway stops driving at situation other than a predefined normal situation.

A road situation detection device according to an embodiment of the present disclosure includes: a memory including instructions; and a processor configured to, by executing the instructions, determine an abnormal situation of vehicle driving for both daytime and nighttime captured images by using an abnormal situation determination model configured to determine an abnormal situation regarding driving of a vehicle in a road region by learning a daytime captured image.

The processor may be configured to input data predicted and processed based on vehicle lights recognized in a nighttime captured image of an object to be determined into an abnormal situation determination model, and to acquire a determination result of an abnormal driving situation in the nighttime captured image from the abnormal situation determination model.

The predicted and processed input data may comprise predicted vehicle object attributes and processed driving feature information associated with the vehicle lights, and wherein the processor is configured to: predict vehicle object attributes, which are mapped to vehicle lights recognized in the nighttime captured image, based on shapes of the lights, sizes of the lights, distances between the lights, or whether the lights are front or rear lights; and reflect a bounding box according to the predicted vehicle object attributes in a movement path of the vehicle lights recognized in the nighttime captured image, process the bounding box as a vehicle object corresponding to each of the vehicle lights, and produce driving feature information regarding the bounding box.

The driving feature information regarding the bounding box may comprise driving speed, driving acceleration, driving angle, and angular velocity, and wherein the determination result from the abnormal situation determination model comprises at least one among vehicle speeding, reverse driving, abnormal driving, and abnormal stopping.

The processor may be configured to, when a determination result of an abnormal driving situation in a nighttime captured image is acquired using the abnormal situation determination model, use the determination result in case that acquisition of the same determination result is maintained even after elapse of a determination waiting time that varies in inverse proportion to a reliability score of the predicted and processed input data.

The reliability score may rise as the degree of mapping between the vehicle lights and the vehicle object attributes increases during prediction of the vehicle object attributes, and as the accuracy of selection of the bounding box according to the predicted vehicle object attributes increases in reflecting the bounding box and processing the bounding box as a vehicle object corresponding to each of the vehicle lights.

A road situation detection device according to an embodiment of the present disclosure includes: a memory including instructions; and a processor configured to, by executing the instructions, set a driving direction attribute of a vehicle object for a road region in a captured image, and determine, based on the driving direction attribute, an abnormal situation regarding driving of the vehicle object in the road region.

The driving direction attribute may be at least one of a forward-driving attribute and a reverse-driving attribute that are set in a relative direction according to a shooting angle of the captured image, based on recognition results of road facility objects installed along a road region in the captured image.

The processor may be configured to verify reliability of the driving direction attribute based on the degree of matching between a training value of a vehicle object trained from a viewpoint matched with the driving direction attribute and a vehicle object recognized from the road region so that an abnormal situation is determined only in case that the reliability of the driving direction attribute is verified.

The abnormal situation may be determined in case that a vehicle object driving in a reverse direction is recognized in a road region with a forward-driving attribute or that a vehicle object driving in a forward direction is recognized in a road region with a reverse-driving attribute, based on a training value of a vehicle object trained from a relative viewpoint according to a shooting angle of the captured image.

A road situation detection device according to an embodiment of the present disclosure includes: a memory including instructions; and a processor configured to, by executing the instructions, detect a vehicle object region based on a luminance difference between regions in a captured image, and determine an abnormal situation regarding driving of a vehicle object by using a type of color identified from the vehicle object region.

The processor may be configured to: set a reference luminance difference to a different value based on a change in ambient illumination on a road section over which the captured image is taken; and detect a region in the captured image, which has a higher luminance than an adjacent region by at least the reference luminance difference, as a vehicle object region.

The reference luminance difference may be set to a larger luminance difference value as ambient illumination in the road section over which the captured image is taken decreases.

The processor may be configured to determine that a case in which the type of color opposite to a driving direction attribute set as a forward or reverse direction for the road section is identified from the vehicle object region or in which the type of color different from that of another vehicle object region is identified from the vehicle object region is an abnormal situation.

The processor may be configured to identify, from the vehicle object region, a red color which is a color characteristic of a rear of a vehicle object, or identify a white color of a headlight and an orange color of a side marker light which are color characteristics of a front of the vehicle object.

According to the present disclosure, specific technical configurations and embodiments for determining anormal situation (e.g., wrong-way driving) regarding the driving of a vehicle object through object recognition from a captured image are realized in relation to a technology for determining, with high reliability, abnormal situations (e.g., wrong-way driving) regarding the driving of the vehicle object from the captured image.

According to the present disclosure, it is possible to: prevent a situation in which wrong-way driving on a sidewalk where bicycles or electric scooters also travel is incorrectly determined as wrong-way driving of a vehicle, and determine an abnormal situation regarding vehicle driving in a roadway with high reliability; reliably determine abnormal situations of vehicle driving for both daytime and nighttime captured images without having to separately train and operate daytime and nighttime models; accurately determine an abnormal situation of vehicle driving even when the shooting angle of a captured image is changed; and, in particular, accurately determine the abnormal situation of a vehicle object even at night when it is difficult to identify the vehicle object.

### BRIEF DESCRIPTION OF THE DRAWINGS

The above and other aspects, features and advantages of the present disclosure will be more apparent from the following detailed description taken in conjunction with the accompanying drawings, in which:

FIG. 1 illustrates an example of a road situation detection environment to which the present disclosure is applied;

FIG. 2 illustrates a configuration of a road situation detection device according to a first embodiment of the present disclosure;

FIG. 3 is a screen illustrating an example of distinguishing between a roadway (a driving road region) and a sidewalk (anon-driving road region) in a captured screen according to a first embodiment of the present disclosure;

FIG. 4 is a flowchart illustrating a method for determining an abnormal situation according to the first embodiment of the present disclosure;

FIG. 5 illustrates a configuration of a road situation detection device according to a second embodiment of the present disclosure;

FIG. 6 is a flowchart illustrating a method for determining an abnormal situation according to the second embodiment of the present disclosure;

FIG. 7 illustrates a configuration of a road situation detection device according to a third embodiment of the present disclosure;

FIG. 8 is a flowchart illustrating a method for determining an abnormal situation according to the third embodiment of the present disclosure;

FIG. 9 illustrates a configuration of a road situation detection device according to a fourth embodiment of the present disclosure; and

FIG. 10 is a flowchart illustrating a method for determining an abnormal situation according to the fourth embodiment of the present disclosure;

### DETAILED DESCRIPTION OF EMBODIMENTS

Technical terms used herein are used merely for illustrating specific embodiments, and it is to be noted that they are not intended to limit technical spirit disclosed in this specification. Also, the technical terms used herein are to be construed by the meanings normally accepted by the person having ordinary skill in the relevant art, unless specifically defined by other meanings in this specification, and it is neither to be construed by excessively comprehensive meanings nor excessively narrow meanings. Also, when the technical terms used herein are determined to be wrong technical terms which fail to represent the technical spirit disclosed in this specification correctly, the terms are to be replaced by the technical terms which can be accurately understood by the person having ordinary skill in the art. Also, the general terms used in this specification are to be construed as defined in the dictionaries or according to context, and they are not to be construed in an excessively narrow meaning.

Also, the singular representation used in this specification includes plural representations unless it is clearly expressed in the context to the contrary. The terms “include” or “is composed of” in this specification are not to be construed to necessarily include all components and all steps cited in this specification, and it should be construed to exclude some components or some steps or further include additional components and steps.

Also, the terms representing an ordinal number such as first, second, etc. used in this specification can be used to explain various components, however, the components are not to be limited by these terms. These terms are used only for discriminate one component from other components. For example, the first component can be entitled as a second component, and similarly, the second component can be entitled as the first component, without departing from the technical scope of the present invention.

In the following, embodiments disclosed in this specification are to be described in detail by referring to the appended figures, wherein the same reference numerals are given to the same or like components irrespective of the number of the figures, and duplicate description on them will be omitted.

Also, when it is determined that a detailed description on a relevant known art will obscure the subject matter disclosed in the specification while describing the technologies disclosed in this specification, the detailed description will be omitted. Also, it is to be noted that the appended figures are only for facilitating the technical spirit disclosed in this specification and the technical spirit are not to be construed to be limited by the appended figures.

Hereinafter, various embodiments of the present disclosure will be described with reference to the accompanying drawings.

The present disclosure relates to a technology for determining abnormal situations regarding the driving of a vehicle object through object recognition from a captured image.

Vehicle wrong-way driving situations on a road are one of the main factors that cause major accidents, alongside icy road accidents.

These wrong-way driving accidents mostly occur during late-night hours when there is low traffic flow and visibility is limited, and the wrong-way driving accidents are highly likely to result in casualties.

Therefore, in order to prevent major accidents caused by wrong-way driving, it is necessary to seek an efficient method for more accurately detecting wrong-way driving situations of vehicles occurring on the road.

In this regard, existing technologies utilize object recognition deep learning models to determine wrong-way driving situations of vehicle objects from captured images.

However, existing determination technologies determine wrong-way driving situations on the overall road without distinguishing between a roadway, in which vehicles are driving, and a sidewalk, in which pedestrians or animals are moving, thereby resulting in lower reliability of the determination results.

Accordingly, in view of the fact that abnormal situations (e.g., vehicle wrong-way driving, abnormal stopping, human/animal intrusion, etc.) on a roadway and a sidewalk may differ, the present disclosure proposes a method for distinguishing a road in a captured image into a roadway and a sidewalk and determining an abnormal driving situation defined for the distinguished roadway (a first embodiment to be described later).

Even in the case of a captured image of the same place by the same imaging device, information that can be obtained from the image differs depends on whether the image is a daytime captured image or a nighttime captured image. Therefore, a deep learning model for determining the wrong-way driving situation of a vehicle object needs to be trained separately for daytime and nighttime conditions.

In this case, the deep learning model needs to be trained separately with daytime and nighttime captured images and continuously updated/operated separately, thereby causing a cost problem. Additionally, there is a limitation in that the determination accuracy decreases in images captured during a time period transitioning from daytime to nighttime or from nighttime to daytime.

Accordingly, the present disclosure proposes a method for reliably determining an abnormal situation related to vehicle driving for both daytime and nighttime captured images by using a single model trained on a daytime captured image (a second embodiment to be described later).

Furthermore, the existing determination technologies have the limitation that the performance of the model may significantly change with changes in the shotting angle, thereby reducing the reliability of the determination results.

Accordingly, the present disclosure proposes a method for determining an abnormal situation regarding the driving of a vehicle object through object recognition adaptable to a change in changes in the shooting angle of a captured image (a third embodiment to be described later).

Furthermore, the present disclosure proposes a method for determining an abnormal situation regarding the driving of a vehicle object by using a type of color identified from a vehicle object region in an in a captured image (a fourth embodiment to be described later).

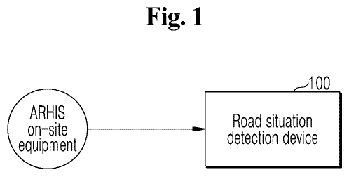

FIG. 1 illustrates an example of a road situation detection environment to which the present disclosure can be applied.

As illustrated in FIG. 1, a road situation detection environment according to an embodiment of the present disclosure may include a road situation detection device 100 for determining an abnormal situation regarding the driving of a vehicle object from a captured image.

The road situation detection device 100 may utilize the existing infrastructure of the Audio-AI-based Road Hazard Information System (ARHIS) to acquire a captured image and may determine an abnormal situation regarding the driving of a vehicle object in the captured image by using an object recognition deep learning model.

Here, ARHIS is a solution that uses deep learning to analyze driving noise/tire friction sound generated on a road section, and determines in real time the road surface condition, the type of a moving object, etc., thereby automatically detecting and identifying road hazard conditions such as icy conditions and whether the moving object is legally driving on the road, and may further support an image capturing function through on-site equipment (body) within the road section.

The road situation detection device 100 may be implemented, for example, as on-site equipment (housing) of an ARHIS accessible via a mobile communication network (e.g., LTE), or as a remote server that operates in conjunction with the on-site equipment of the ARHIS.

In the following, the road situation detection device 100 will be described assuming that the road situation detection device 100 is implemented in the form of a server. That is, the road situation detection device 100 may receive an image captured by the ARHIS on-site equipment in a road section and determine an abnormal situation regarding the driving of a vehicle object from the captured image.

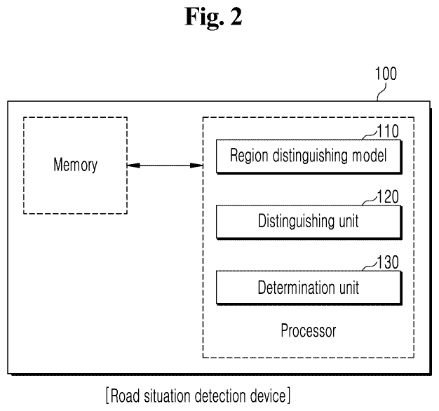

Hereinafter, a road situation detection device 100 according to a first embodiment of the present disclosure will be described in detail with reference to FIG. 2.

As illustrated in FIG. 2, the road situation detection device 100 according to an embodiment of the present disclosure may include a memory including instructions, and a processor configured to execute the instructions in the memory.

In particular, according to the first embodiment of the present disclosure, the processor may include a region distinguishing model 110, a distinguishing unit 120, and a determination unit 130 according to functional elements implemented through the execution of the instructions.

The road situation detection device 100 according to an embodiment of the present disclosure may distinguish between a roadway and a sidewalk and determination of an abnormal situation regarding the driving of a vehicle object from a captured image through the above-described functional elements 110, 120, and 130 of the processor.

The distinguishing unit 120 is responsible for determining a roadway in a captured image through the distinction between regions in the captured image.

More specifically, the distinguishing unit 120 may distinguish between a driving road region and a non-driving road region in the captured image, based on the region distinguishing model 110, and may determine the distinguished driving road region as the roadway.

To this end, in the present disclosure, the region distinguishing model 110 for distinguishing between a driving road region and a non-driving road region from a captured image is pretrained and utilized.

Specifically, the region distinguishing model 100 may be a deep learning model that is generated/constructed by being trained on multiple images captured/collected under the same shooting conditions as those of a captured image of an object for which an abnormal driving situation is to be determined.

That is, when a captured image of an object for which an abnormal driving situation is to be determined is input, the region distinguishing model 110 utilized in the present disclosure may reflect training results obtained from pretraining on multiple images captured/collected under the same shooting conditions, and may distinguish and output a driving road region and a non-driving road region in the current image.

A more specific embodiment of the region distinguishing model 110 will be described.

The region distinguishing model 110 may be a deep learning model that is trained/defined to distinguish between a driving road region, in which vehicles travel, and a non-driving road region, in which non-vehicle moving objects move, by being trained on training data based on the movement speed and movement trajectory of unspecified moving objects identified in a captured image on the basis of multiple images captured/collected under the same shooting conditions as those of a captured image of an object for which an abnormal driving situation is to be determined.

An aspect of the present disclosure is to propose a method for enhancing the reliability/accuracy of the region distinguishing model 110 while reducing the training complexity in the process of training the region distinguishing model 110.

To this end, in the present disclosure, the model may be trained on training data based on the movement speed and movement trajectory of an unspecified moving object identified in a captured image without distinguishing/specifying the type of moving object in the captured image (e.g., whether the moving object is a vehicle or not).

Specifically, in the present disclosure, based on multiple images captured/collected under the same shooting conditions, the region distinguishing model 110 may be trained/constructed to distinguish between a driving road region, a non-driving road region, and a non-interest region by being trained on training data based on the movement speed and movement trajectory of an unspecified moving object identified in each image.

For example, in the present disclosure, the region distinguishing model 110 may be trained/constructed to distinguish a region in which multiple unspecified moving objects are located that move at movement speeds belonging to a predefined vehicle movement speed range and along movement trajectories belonging to a trajectories range (or a trajectory range having a mutual similarity equal to or greater than a certain value) as a driving road region, a region in which other unspecified moving objects are located as a non-driving road region, and a region in which no unspecified moving objects are located as a non-interest region.

Thus, in the present disclosure, during the training process of the region distinguishing model 110, the training complexity may be reduced by using a training method that does not distinguish/specify the types of moving objects (e.g., whether the moving object are vehicles or not) within in a captured image, and then the region distinguishing model 110 may be trained/constructed.

Furthermore, in the present disclosure, in the process of training the region distinguishing model 110, in order to enhance the reliability/accuracy of the region distinguishing model 110, relevant data of a specific moving object (e.g., an electric scooter, a bicycle, etc.) that can move on both a roadway and a sidewalk may be excluded from the training data so as not to be reflected in the training of the region distinguishing model 110.

According to laws such as the Road Traffic Act, electric scooters and bicycles are not allowed to move on the sidewalk and are required to move along the right edge of a bicycle lane or a roadway. However, in the present disclosure, while considering that electric scooters and bicycles frequently travel on a sidewalk in practice, these legal issues will be disregarded.

In the present disclosure, sound data (e.g., driving noise/tire friction sound) on a road section, which can be obtained from ARHIS, is utilized to specify relevant data of a specific moving object that is to be excluded from training data.

That is, in the present disclosure, tire friction sound of a specific moving object (e.g., an electric scooter, a bicycle, etc.) that can move on both a roadway and a sidewalk is preset and used to select relevant data of the specific moving object (e.g., an electric scooter, a bicycle, etc.) that is to be excluded from training data.

Specifically, in the present disclosure, multiple captured images to be used to train the region distinguishing model 110 may be collected from a device that captures an image, such as ARHIS's on-site equipment in a road section, and tire friction sound data may be acquired at each time point at which each image is captured.

Accordingly, in the present disclosure, based on the tire friction sound data acquired at each time point when each of the multiple images used for training is captured, an unspecified moving object, among moving objects identified in each captured image, in which a predetermined an audio waveform of a specific tire friction sound (e.g., an audio waveform of a specific tire friction sound that specifies an electric scooter and a bicycle) is detected may be selected as a specific moving object (e.g., an electric scooter, a bicycle, etc.) that is capable of moving on both a roadway and a sidewalk.

In the present disclosure, as described above, in the process of training the region distinguishing model 110 with training data, which is based on the movement speed and movement trajectory of an unspecified moving object identified in each captured image, on the basis of the multiple captured images, relevant data of a specific moving object (e.g., an electric scooter, a bicycle, etc.) identified based on sound data obtained from the ARHIS, i.e. the tire friction sound, is excluded from the training data so that the specific moving object (e.g., an electric scooter, a bicycle, etc.) is not reflected in the training of the region distinguishing model 110.

For example, excluding relevant data of a specific object (e.g., an electric scooter, a bicycle, etc.) from training data may include excluding, from the training data, a captured image in which the specific moving object (e.g., an electric scooter, a bicycle, etc.) is present, or excluding, from the training data, only the movement speed and movement trajectory of the specific object (e.g., an electric scooter, a bicycle, etc.) among multiple unspecified objects in the captured image in which the specific object (e.g., an electric scooter, a bicycle, etc.) is present.

Thus, in the present disclosure, in the process of training the region distinguishing model 110, the training complexity is reduced by a training method that does not distinguish/specify the type of moving object (e.g., whether the moving object is a vehicle or not, etc.) in the captured image, and relevant data of a specific moving object (e.g., an electric scooter, a bicycle, etc.), which has been selected by utilizing sound data (e.g., driving noise/tire friction sound) generated in a road section, is not excluded from training data so as not to be reflected in training, thereby enhancing the reliability/accuracy of the region distinguishing model 110.

Furthermore, after the training of the region distinguishing model 110 as described above, the road situation detection device 100 of the present disclosure may input a predetermined captured image for verification and verify the reliability of the distinguishing result (a driving road region and a non-driving road region), output from the region distinguishing model 110, by using an audio waveform of a specific tire friction sound (e.g., an audio waveform of a specific tire friction sound that specifies an electric scooter and a bicycle).

For example, in the present disclosure, based on the tire region friction sound data acquired at the time a predetermined captured image for verification was captured, the reliability of the region distinguishing model 110 may be determined to be acceptable if, with respect to the current predetermined captured image for verification, the audio waveforms of a specific tire friction sound (e.g., audio waveforms of the specific tire friction sounds specifying the electric scooter and the bicycle) in tire region friction sound data related to a driving road region distinguished by the region distinguishing model 110 is below a predetermined threshold level (e.g., 0-2%).

The distinguishing unit 120 will be described again.

The distinguishing unit 120 may input a captured image of an object, for which an abnormal driving situation is to be determined, to the region distinguishing model 110, which is trained with the training method having low training complexity and enhanced reliability/accuracy and proposed by the present disclosure as described above, and obtain, from the region distinguishing model 110, the result of distinguishing between a driving road region and a non-driving road region in the captured image.

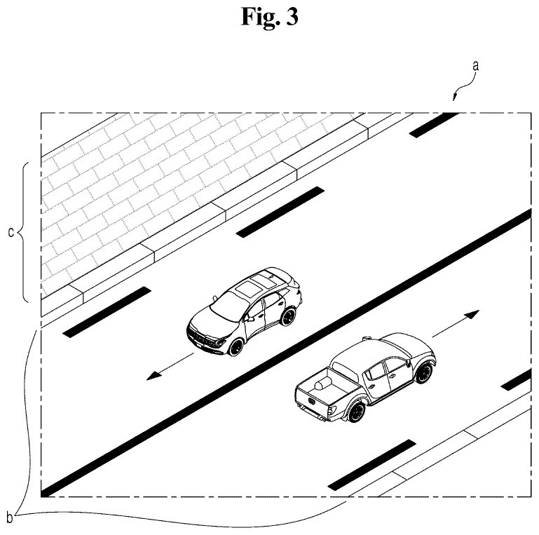

As illustrated in FIG. 3, the distinguishing unit 120 may determine a driving road region b distinguished in a captured image a as a roadway in the captured image through the region distinguishing model 110, and furthermore may determine a non-driving road region c as a sidewalk in the captured image.

The determination unit 130 is responsible for determining an abnormal situation regarding the driving of a vehicle object in the roadway determined by the distinguishing unit 120 from the captured image.

To describe the embodiment in more detail, a road may be distinguished into a roadway, where vehicles travel, and a sidewalk, where people/animals, etc. move.

Abnormal situations that may occur on the roadway, such as vehicle wrong-way driving, abnormal stopping, and intrusion by people or animals, may be different from abnormal situations that may occur on the sidewalk, such as falling of a facility or vehicle intrusion.

Accordingly, in the present disclosure, with respect to a roadway (a driving road region) determined by the distinguishing unit 120 in a real-time captured image, the determining unit 130 may determine whether the driving of a vehicle object recognized in the roadway (the driving road region) belongs to an abnormal driving situation defined for the roadway, thereby determining an abnormal situation regarding the driving of the vehicle object in the roadway.

For example, when the driving direction of a vehicle object recognized in a roadway (a driving road region) in a captured image is recognized to be opposite or different from a forward driving direction designated in the roadway (the driving road region) of the current captured image, the determination unit 130 may recognize/determine that the driving of the vehicle object is a wrong-way driving situation, and may determine that the driving of the vehicle object is an abnormal driving situation defined for the roadway.

Alternatively, when a vehicle object recognized in a roadway (a driving road region) of a captured image stops driving in situations other than a predefined normal situation (e.g., the presence of a traffic light within xx meters in the forward driving direction), the determination unit 130 may recognize/determine that the driving stop is an abnormal stopping situation of the vehicle object, and may determine that the driving stop is an abnormal driving situation defined for the roadway.

In this way, the determining unit 130 may determine an abnormal driving situation (e.g., vehicle wrong-way driving, abnormal stopping, human/animal intrusion, etc.) defined for the roadway (the driving road region) determined by the distinguishing unit 120 from a real-time captured image.

In the present disclosure, a technical method using an existing deep learning model may be adopted for the determination unit 130 to recognize a vehicle object in a roadway (a driving road region) of a captured image and to determine an abnormal situation regarding the driving of the vehicle object. Various other technical methods may be adopted to perform the recognition and determination of the abnormal situation regarding the driving.

Furthermore, the determining unit 130 may determine an abnormal situation (e.g., such as falling of a facility, vehicle intrusion, etc.) defined for a sidewalk (a non-driving road region) determined by the distinguishing unit 120 from a real-time captured image.

As described above, in consideration of the fact that the abnormal situations on the roadway and the sidewalk may be different, the road situation detection device 100 of the present disclosure may distinguish a road in a captured image into a roadway and a sidewalk, and determine an abnormal driving situation defined for the distinguished roadway, thereby preventing an incorrect determination situation such as the determination that wrong-way driving on the sidewalk where a bicycle or an electric scooter travels is wrong-way driving of a vehicle, and determining an abnormal situation regarding vehicle driving on the roadway with higher reliability.

In particular, in distinguishing a road in a captured image into a roadway and a sidewalk, the road situation detection device 100 of the present disclosure may utilize the region distinguishing model 110, which is trained in a feature-based way that can reduce the learning complexity while enhancing the reliability/accuracy of a model, thereby significantly enhancing the reliability of determination regarding vehicle abnormality situation in the roadway.

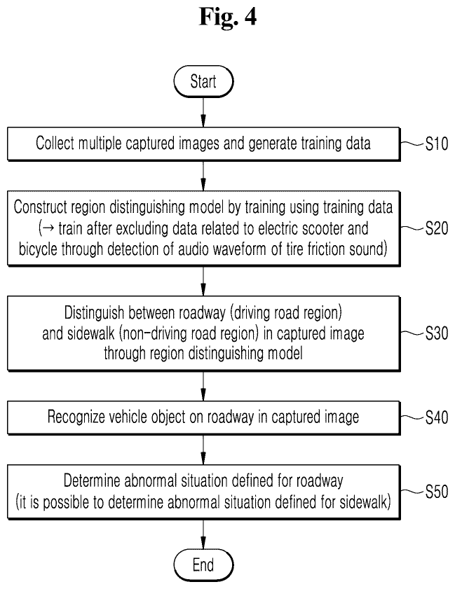

Hereinafter, a method for determining an abnormal situation according to a first embodiment of the present disclosure will be described with reference to FIG. 4.

For ease of description, the following description will refer to the road situation detection device 100, described with reference to FIG. 2, as an entity responsible for performing the abnormal situation determination method.

The road situation detection device 100 may, based on the pretrained region distinguishing model 110, distinguish between a roadway (a driving road region) and a sidewalk (a non-driving road region) in a captured image of an object for which an abnormal driving situation is to be determined (S30).

To this end, the region distinguishing model 110 is pretrained to distinguish between the driving and non-driving road regions from the captured image, and is utilized in the present disclosure.

Specifically, the road situation detection device 100 collects multiple images captured under the same shooting conditions as those of a captured image of an object for which an abnormal driving situation is to be determined, and generates training data by using the captured images (S10).

To describe a more specific embodiment, the road situation detection device 100 may, based on multiple images captured/collected under the same shooting conditions as those of a captured image of an object for which an abnormal driving situation is to be determined, generate training data based on the movement speed and movement trajectory of unspecified moving objects identified in the captured images, and train a model by using the training data, thereby constructing the region distinguishing model 110 as a deep learning model that is trained/defined to distinguish between a driving road region in which a vehicle travels and a non-driving road region in which a non-vehicle moving object moves (S20).

That is, as described above, an aspect of the present disclosure to propose a method which can enhance the reliability/accuracy of the region distinguishing model 110 while reducing the training complexity in the process of training the region distinguishing model 110.

To this end, in the present disclosure, training data based on the movement speed and movement trajectory of an unspecified moving object identified in a captured image may be used for training, without distinguishing/specifying the type of moving object in the captured image (e.g., whether the moving object is a vehicle or not, etc.).

Specifically, in the present disclosure, the region distinguishing model 110 may be trained/constructed to distinguish between a driving road region, a non-driving road region, and a non-interest region by being trained with training data based on the movement speed and movement trajectory of an unspecified moving object identified in each captured image, based on multiple images captured/collected under the same shooting conditions.

In this way, in the present disclosure, in the process of training the region distinguishing model 110, the training complexity may be reduced by using a training method that does not distinguish or specify the type of moving object (e.g., whether the moving object is a vehicle or not) in a captured image, thereby enabling the training and construction of the region distinguishing model 110.

Furthermore, in step S20 of training the region distinguishing model 110, in order to improve the reliability/accuracy of the region distinguishing model 110, the road situation detection device 100 may exclude, from training data, relevant data of a specific moving object (e.g., an electric scooter, a bicycle, etc.), which can move on both a roadway and a sidewalk, so as not to be reflected in the training of the region distinguishing model 110.

In the present disclosure, sound data (e.g., driving noise/tire friction sound) in a road section that can be obtained from ARHIS is used to specify the relevant data of the specific moving object which is to be excluded from the training data.

That is, in the present disclosure, tire friction sound of the specific moving object (e.g., an electric scooter, a bicycle, etc.) that can move on both a roadway and a sidewalk is specified and preset to be used to select the relevant data of the specific moving object (e.g., an electric scooter, a bicycle, etc.) which is to be excluded from the training data.

Specifically, in the present disclosure, from a device for capturing an image, such as on-site equipment (a housing) of an ARHIS in a road section, multiple captured images for use in training the region distinguishing model 110 may be collected, and tire friction sound data acquired at each time point when each image is captured may be acquired.

Accordingly, in the present disclosure, based on tire friction sound data acquired at time points when multiple images used for training are captured, a moving object in which a predetermined an audio waveform of a specific tire friction sound (e.g., an audio waveform of a specific tire friction sound that specifies an electric scooter and a bicycle) is detected among unspecified moving objects identified in each captured image may be selected as the specific moving object (e.g., an electric scooter, a bicycle, etc.) that is capable of moving on both a roadway and a sidewalk.

In the present disclosure, as described above, in step S20 of training the region distinguishing model 110 with training data based on the movement speed and movement trajectory of an unspecified moving object identified in each captured image on the basis of multiple images, relevant data of a specific moving object (e.g., an electric scooter, a bicycle, etc.) identified based on sound data obtained from the ARHIS, i.e., tire friction sound, is excluded from training data so that the specific moving object (e.g., an electric scooter, a bicycle, etc.) is not reflected in the training of the region distinguishing model 110.

Thus, according to the abnormal situation determination method of the present disclosure, in step S20 of training the region distinguishing model 110, the training complexity is reduced by using a training method that does not distinguish/specify the type of moving object (e.g., whether the moving object is a vehicle or not, etc.) in a captured image, while the reliability/accuracy of the region distinguishing model 110 is enhanced by ensuring that relevant data of a specific moving object (e.g., an electric scooter, a bicycle, etc.) selected using sound data (e.g., driving noise/tire friction sound) is not reflected in training.

Continuing with the description, based on the region distinguishing model 110 previously trained/constructed in steps S10 and S20 above, the road situation detection device 100 may distinguish between a roadway (a driving road region) and a sidewalk (a non-driving road region) in a real-time captured image of an object for which an abnormal driving situation is to be determined (S30).

Then, with respect to the roadway (the driving road region), distinguished in step S30 in relation to the real-time captured image, the road situation detection device 100 may determine an abnormal situation regarding the driving of a vehicle object recognized in the roadway (the driving road region) by determining whether the driving of the recognized vehicle object in the roadway belongs to an abnormal driving situation defined for the roadway (S40 and S50).

For example, when the driving direction of a vehicle object recognized in a roadway (a driving road region) of a captured image is recognized to be opposite or different from a forward driving direction designated in the roadway (the driving road region) of the current captured image, the road situation detection device 100 may recognize/determine that the driving of the vehicle object is a wrong-way driving situation, and determine that the driving of the vehicle object is an abnormal driving situation defined for the roadway.

Alternatively, when a vehicle object recognized in a roadway (a driving road region) of a captured image stops driving in situations other than a predefined normal situation (e.g., the presence of a traffic light within xx meters in the forward driving direction), the road situation detection device 100 may recognize/determine that the driving stop is an abnormal stopping situation and determine that the driving stop is an abnormal driving situation defined for the roadway.

In this way, with respect to the roadway (the driving road region) distinguished in step S30 in the real-time captured image, the road situation detection device 100 may determine an abnormal driving situation (e.g., vehicle wrong-way driving, abnormal stopping, human/animal intrusion, etc.) defined for the roadway (S40 and S50).

As described above, in consideration of the fact that the abnormal situations on the roadway and the sidewalk may be different, a road in a captured image may be distinguished into a roadway and a sidewalk, and an abnormal driving situation defined for the distinguished roadway may be determined, thereby preventing an incorrect determination situation such as the determination that wrong-way driving on the sidewalk where a bicycle or an electric scooter travels is wrong-way driving of a vehicle, and determining an abnormal situation regarding vehicle driving on the roadway with higher reliability.

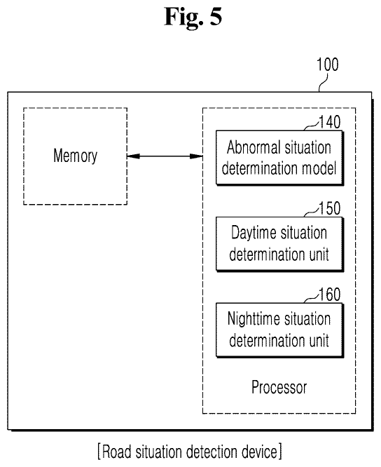

Hereinafter, with reference to FIG. 5, a configuration of a road situation detection device 100 according to a second embodiment of the present disclosure will be described in detail.

As illustrated in FIG. 5, the road situation detection device 100 according to the second embodiment of the present disclosure may include a memory including instructions, and a processor configured to execute the instructions in the memory. In particular, the processor may include an abnormal situation determination model 140, a daytime situation determination unit 150, and a nighttime situation determination unit 160 as functional elements implemented through the execution of the instructions.

The road situation detection device 100 according to an embodiment of the present disclosure may determine abnormal situations regarding vehicle driving with respect to both daytime and nighttime captured images by using a single model through the above-described functional elements 140, 150, and 160 of the processor.

The abnormal situation determination model 140 may be generated/constructed to determine an abnormal situation regarding the driving of a vehicle in a road region by learning a daytime captured image.

For example, the abnormal situation determination model 140 may be a deep learning model that is generated/constructed by learning multiple daytime captured images captured/collected under the same shooting conditions (e.g., shooting location, shooting height and direction, daytime shooting etc.) as those of a captured image of an object for which an abnormal driving situation is to be determined.

The abnormal situation determination model 140 includes, as input data, vehicle object attributes for a vehicle object recognized in an image and driving feature information related to the movement of the vehicle object in the image.

Accordingly, the abnormal situation determination model 140 may be a deep learning model defined to output data resulting from determining abnormal situations regarding the driving of the corresponding vehicle object through a determination algorithm that has been generated/constructed with pretraining on the above-described input data (the vehicle object attributes/the driving feature information).

The vehicle object attributes may refer to the vehicle type (e.g., sedan, van, bus, truck, etc.) and the vehicle classification (e.g., vehicle class, vehicle model, etc.).

The driving feature information may refer to a driving speed, a driving acceleration, a driving angle, an angular velocity, etc. related to the driving of a vehicle object.

When a captured image of an object for which an abnormal driving situation is to be determined is a daytime captured image, the daytime situation determination unit 150 is responsible for determining an abnormal situation regarding the driving of a vehicle in a road region of a road region in the current captured image by using the abnormal situation determination model 140 described above.

For example, the daytime situation determination unit 150 may use an existing object recognition deep learning model or other techniques to obtain/extract vehicle object attributes and driving feature information of vehicle objects from the daytime captured image of an object for which an abnormal driving situation is to be determined.

The daytime situation determination unit 150 may input the vehicle object attributes and the driving feature information of each vehicle object obtained from the current daytime captured image as input data into the abnormal situation determination model 140, and may obtain, from the abnormal situation determination model 140, data resulting from determining an abnormal situation regarding the driving of each vehicle object in the road region of the daytime captured image.

In the present disclosure, determining an abnormal driving situation of a vehicle object by the daytime situation determination unit 150 for a daytime captured image may be easily implemented because the abnormal situation determination model 140 is a model generated/constructed by learning multiple daytime captured images captured/collected under the same shooting conditions (e.g., shooting location, shooting height and direction, daytime shooting, etc.) as those of a captured image of an object for which an abnormal driving situation is to be determined.

When a captured image of an object for which an abnormal driving situation is to be determined is a nighttime captured image, the nighttime situation determination unit 160 is responsible for determining an abnormal situation regarding the driving of a vehicle within a road region in the current image by using the above-described abnormal situation determination model 140.

As described above, the abnormal situation determination model 140 is a model generated/constructed by learning a daytime captured image. Therefore, in the present disclosure, additional reflection factors are required to determine an abnormal driving situation of a vehicle object in a nighttime captured image by using the abnormal situation determination model 140.

An aspect of the present disclosure is to obtain the result of determination of an abnormal driving situation in a nighttime captured image from the abnormal situation determination model 140 by utilizing a vehicle light, which is relatively clearly recognized/distinguished in the nighttime captured image, as an additional reflection factor.

Specifically, when a captured image of an object for which an abnormal driving situation is to be determined is a nighttime captured image, the nighttime situation determination unit 160 may input the input data, predicted and processed based on the vehicle lights recognized in the current nighttime captured image, into the abnormal situation determination model 140, and obtain the result of determining an abnormal driving situation in the current nighttime captured image from the abnormal situation determination model 140.

In a specific embodiment, the input data predicted and processed by the nighttime situation determination unit 160 may include predicted vehicle object attributes and processed driving feature information, which are related to vehicle lights.

For example, based on the shape of vehicle lights recognized in a nighttime captured image of an object for which an abnormal driving situation is to be determined, the size of the lights, the distance between the lights, or whether the lights are front or rear lights, the nighttime situation determination unit 160 may predict vehicle object attributes that are mapped to the vehicle lights recognized in the current nighttime captured image.

That is, the nighttime situation determination unit 160 may utilize existing object recognition deep learning models or other techniques to recognize/distinguish the shape of vehicle lights, the size of the lights, the distance between the lights, and whether the lights are front or rear lights for each vehicle object in a road region from a nighttime captured image of an object for which an abnormal driving situation is to be determined.

Thus, based on the shape of vehicle lights, the size of the lights, the distance between the lights, or whether the lights are front or rear lights, recognized/distinguished for each vehicle object in the road region, the nighttime situation determination unit 160 may predict vehicle object attributes that are mapped to each vehicle light recognized in the current nighttime captured image by specifying the vehicle object attribute that is mapped to each vehicle light from a database in which vehicle object attributes to be mapped are defined according to the shape of various vehicle lights, the size of the lights, the distance between the lights, or whether the lights are front or rear lights.

The nighttime situation determination unit 160 may reflect a bounding box according to the predicted vehicle object attributes in the movement path of each vehicle light recognized in the current nighttime captured image, process the bounding box as a vehicle object corresponding to each light, and then produce driving feature information regarding the bounding box.

For example, the size, shape, etc. of each bounding box may vary depending on the predicted vehicle object attributes (e.g., the vehicle type (e.g., sedan, van, bus, truck, etc.) or the vehicle classification (e.g., vehicle class, model, etc.)).

The nighttime situation determination unit 160 may reflect a bounding box, with a size/shape varying depending on the predicted vehicle object attributes, in the movement path of each vehicle light recognized in the current nighttime captured image to process the bounding box as a vehicle object corresponding to each vehicle light, and produce driving feature information (e.g., driving speed, driving acceleration, driving angle, angular velocity, etc.) regarding the bounding box.

The nighttime situation determination unit 160 may utilize vehicle lights recognized in a nighttime captured image as an additional reflection factor to predict and process vehicle object attributes and driving feature information for each vehicle object in the nighttime captured image, thereby generating input data.

Subsequently, the nighttime situation determination unit 160 may input the vehicle object attributes and the driving feature information for each vehicle object, generated by the prediction and processing as described above with respect to the current nighttime captured image, into the abnormal situation determination model 140 as input data, and obtain, from the abnormal situation determination model 140, data resulting from determining an abnormal situation regarding the driving of each vehicle object in the road region of the nighttime captured image.

According to an embodiment, in the present disclosure, a daytime period during which the daytime situation determination unit 150 operates and a nighttime period during which the nighttime situation determination unit 160 operates may be set separately, thereby allowing the daytime situation determination unit 150 to process an image captured during the operation time period thereof as daytime captured image, and the nighttime situation determination unit 160 to process an image captured during the operation time period thereof as a nighttime captured image.

As described above, the present disclosure realizes a specific technical configuration in which the abnormal situation determination model 140 can be generated by learning the daytime captured image, and input data predicted and processed based on vehicle lights recognized in a nighttime captured image can be input into the abnormal situation determination model 140 to obtain the result of determining an abnormal driving situation even for the nighttime captured image.

When the result of determining an abnormal driving situation in a nighttime captured image is acquired using the abnormal situation determination model 140 as described above, the nighttime situation determination unit 160 may use the current determination result only if the current determination result is to be determined as a valid result.

In one example, when the acquisition of the same determination result is maintained even after the elapse of a determination waiting time that varies in inverse proportion to the reliability score of the input data, i.e., the predicted and processed input data, which is input into the abnormal situation determination model 140 for the current determination result, the nighttime situation determination unit 160 may determine that the current determination result is a valid result and use the current determination result.

In other words, when input data predicted and processed for input into the abnormal situation determination model 140 is evaluated as having a high reliability score, the nighttime situation determination unit 160 may use the current determination result if the acquisition of the same determination result is maintained for a relatively short determination waiting time (e.g., 0 seconds, 0.1 seconds, etc.).

On the other hand, when input data predicted and processed for input into the abnormal situation determination model 140 is evaluated as having a low reliability score, the nighttime situation determination unit 160 may use the current determination result only after the acquisition of the same determination result is maintained for a relatively long determination waiting time (e.g., 1 second, 2 seconds, etc.).

Thus, in the present disclosure, the “reliability score of predicted and processed input data” serves as a criterion for determining whether the result of determining an abnormal driving situation in a nighttime captured image is valid.

The “reliability score of predicted and processed input data” may be defined to rise as the degree of mapping between vehicle lights and vehicle object attributes increases during the prediction of the vehicle object attributes in the input data, and may be defined to rise as the accuracy of the selection of a bounding box according to the predicted vehicle object attributes increases in reflecting the bounding box and processing the bounding box as a vehicle object of the vehicle light.

As described above, in the present disclosure, a single abnormal situation determination model 140 trained on daytime captured images may be used to determine an abnormal situation regarding vehicle driving with respect to both daytime and nighttime captured images.

In the present disclosure, the determination result from the abnormal situation determination model 140 may include at least one of the speeding, wrong-way driving, abnormal driving, and abnormal stopping of a vehicle.

For example, in the present disclosure, when the driving speed of a vehicle object recognized in a road region of a daytime or nighttime captured image is recognized to be equal to or higher than the driving speed limit specified for the road region of the current captured image, the vehicle object may be recognized/determined to be in a speeding situation and determined to be in an abnormal driving situation.

Alternatively, in the present disclosure, when the driving direction of a vehicle object recognized in a road region of a daytime or nighttime captured image is recognized to be opposite or different from the forward driving direction specified for the road region of the current captured image, the vehicle object may be recognized/determined to be in a reverse driving situation and determined to be in an abnormal driving situation.

Alternatively, in the present disclosure, when the movement of a vehicle object recognized in a road region of a daytime or nighttime captured image is recognized as a predefined abnormal lane change (e.g., driving across lanes for XX seconds or more, or repeatedly changing the same lane within XX seconds, etc.), the vehicle object may be recognized/determined to be an abnormal driving situation and determined to be in an abnormal driving situation.

Alternatively, in the present disclosure, when a vehicle object recognized in a road region of a daytime or nighttime captured image stops driving situations other than a predefined normal situation (e.g., presence of a traffic light within xx meters in the forward driving direction), the vehicle object may be recognized/determined to be in an abnormal stopping situation and determined to be in an abnormal driving situation.

Furthermore, according to an embodiment, in the present disclosure, the time period transitioning from daytime to nighttime or the time period transitioning from nighttime to daytime may be set as the time zone in which both the daytime situation determination unit 150 and the nighttime situation determination unit 160 operate, and the data of determination results, which the daytime situation determination unit 150 and the nighttime situation determination unit 160 obtain from the abnormal situation determination model 140 for the same captured image, may be merged and used.

Thus, in the present disclosure, the single abnormal situation determination model 140, trained on daytime captured images, may be used to determine abnormal situations regarding vehicle driving for both daytime and nighttime captured images, while avoiding degradation of the determination accuracy in, particularly, an image captured during a time period that transitions between daytime and nighttime.

The foregoing describes an embodiment that uses the abnormal situation determination model 140 to implement each of the daytime situation determination unit 150 for determining an abnormal driving situation in a daytime captured image and the nighttime situation determination unit 160 for determining an abnormal driving situation in a nighttime captured image. This is merely one example.

In the present disclosure, the abnormal situation determination model 140 may be used to implement a single functional unit for determining abnormal driving situations in daytime/nighttime captured images.

As described above, the road situation detection device 100 of the present disclosure may generate a model trained on daytime captured images, and may input the input data predicted and processed based on vehicle lights recognized in a nighttime captured image into the model to obtain the result of determining an abnormal driving situation in the nighttime captured image, thereby determining abnormal situations regarding vehicle driving in both daytime and nighttime images by using the single model trained on the daytime captured images.

As a result, according to the present disclosure, a single model trained on daytime images may be used to reliably determine abnormal driving situations in both daytime and nighttime captured images, thereby avoiding the degradation of the determination accuracy even in images captured during a time period that transitions between daytime and nighttime, and solving cost-related problems that arise from having to separately train and operate daytime and nighttime models.

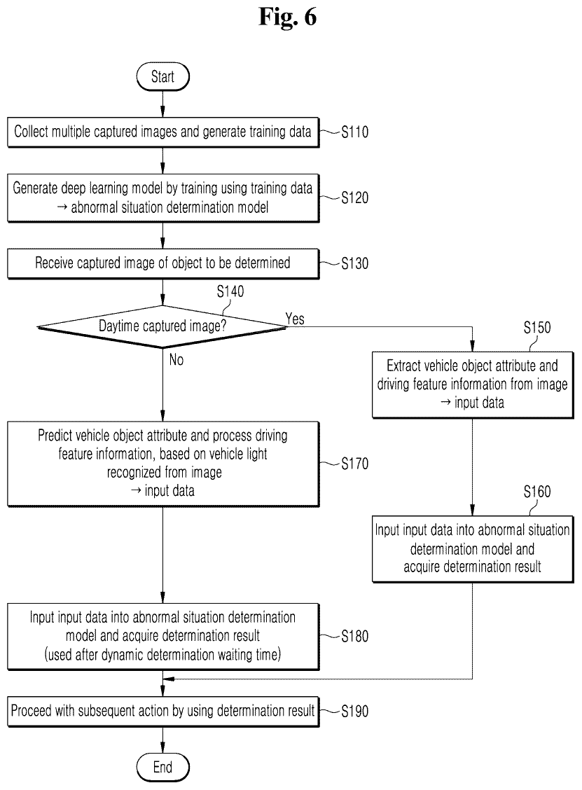

Hereinafter, a method for determining an abnormal situation according to a second embodiment of the present disclosure will be described with reference to FIG. 6.

For ease of description, the following description will refer to the road situation detection device 100, described with reference to FIG. 5, as an entity responsible for performing the abnormal situation determination method.

The road situation detection device 100 generates an abnormal situation determination model 140 for determining an abnormal situation regarding the driving of a vehicle in a road region by being trained on daytime captured images (S110 and S120).

Specifically, according to the abnormal situation determination method of the present disclosure, multiple daytime captured images for training, taken under the same shooting conditions (e.g., shooting location, shooting height and direction, daytime shooting, etc.) as those of a captured image of an object for which an abnormal driving situation is to be determined, are collected, and training data is generated therefrom (S110).

Subsequently, according to the abnormal situation determination method of the present disclosure, the abnormal situation determination model 140 may be trained on the training data in step S110 and, as a result, be generated/constructed as a model for determining an abnormal situation regarding the driving of a vehicle in a road region of a captured image (S120).

When the image of the object to be determined is received (S130) and when the image is a daytime captured image (S140 Yes), the road situation detection device 100 may utilize an existing object recognition deep learning model or other techniques to acquire/extract vehicle object attributes and driving feature information of vehicle objects from the current daytime image (S150).

The road situation detection device 100 may input the vehicle object attributes and the driving feature information for each vehicle object, acquired from the current daytime captured image, as input data into the abnormal situation determination model 140, and obtains data from the abnormal situation determination model 140, and obtain data resulting from determining an abnormal situation regarding the driving of each vehicle object in the road region of the daytime captured image (S160).

When an image of the object to be determined is received (S130) and when the image is a nighttime captured image (S140 No), the road situation detection device 100 generates input data to be input into the abnormal situation determination model 140 by utilizing vehicle lights as an additional reflection factor (S170).

Specifically, the road situation detection device 100 may predict vehicle object attributes that are mapped to vehicle lights recognized in the current nighttime image, based on the vehicle lights recognized in the current nighttime image (e.g., the shape of the vehicle lights, the size of the vehicle lights, the distance between the lights, whether the vehicle lights are front or rear lights, etc.).

The road situation detection device 100 may reflect a bounding box according to the predicted vehicle object attributes on the movement path of each vehicle light recognized in the current nighttime captured image, process the bounding box as a vehicle object corresponding to each vehicle light, and then produce driving feature information regarding the bounding box.

For example, the size, shape, etc. of each bounding box may vary depending on the predicted vehicle object attributes (e.g., the vehicle type (e.g., sedan, van, bus, truck, etc.) or the vehicle class (e.g., vehicle class, model, etc.)).

The road situation detection device 100 may reflect a bounding box, with a size/shape varying depending on the predicted vehicle object attributes, in the movement path of each vehicle light recognized in the current nighttime captured image, process the bounding box as a vehicle object corresponding to each vehicle light, and produce driving feature information (e.g., driving speed, driving acceleration, driving angle, angular velocity, etc.) regarding the bounding box.

In this way, the road situation detection device 100 may utilize vehicle lights recognized in a nighttime captured image as an additional reflection factor to predict, process vehicle object attributes and driving feature information for each vehicle object in the nighttime captured image, thereby generating input data (S170).

Subsequently, the road situation detection device 100 may input the vehicle object attributes and the driving feature information for each vehicle object, generated by the prediction and processing in step 170 with respect to the current nighttime captured image, into the abnormal situation determination model 140 as input data, and obtain, from the abnormal situation determination model 140, data resulting from determining an abnormal situation regarding the driving of each vehicle object in the road region of the nighttime captured image (S180).

Accordingly, the road situation detection device 100 may determine abnormal situations regarding vehicle driving in both daytime and nighttime captured images by using the single abnormal situation determination model 140 trained on the daytime captured images (S160 and S180).

The road situation detection device 100 may use the determination result to proceed with a subsequent action (e.g., an abnormal situation notification, warning sound, calling relevant authorities, etc.) (S190).

More specifically, when the acquisition of the same determination result is maintained even after the elapse of a determination waiting time that varies in inverse proportion to the reliability score of the input data, i.e., the predicted and processed input data, which is input into the abnormal situation determination model 140 for the current determination result in step S180, the road situation detection device 100 may determine that the current determination result is a valid result, and may use the current determination result in step S190.

As described above, according to the method for determining an abnormal situation according to the second embodiment of the present disclosure, a model trained on daytime captured images may be generated, and input data predicted and processed based on vehicle lights recognized in a nighttime captured image may be input into the model to acquire the result of determining an abnormal driving situation in the nighttime captured image, thereby determining abnormal situations regarding vehicle driving in both daytime and nighttime captured images by using a single model trained on daytime captured images.

As a result, according to the present disclosure, a single model trained on daytime images may be used to reliably determine abnormal driving situations in both daytime and nighttime captured images, thereby avoiding the degradation of the determination accuracy even in images captured during a time period that transitions between daytime and nighttime, and solving cost-related problems that arise from having to separately train and operate daytime and nighttime models.

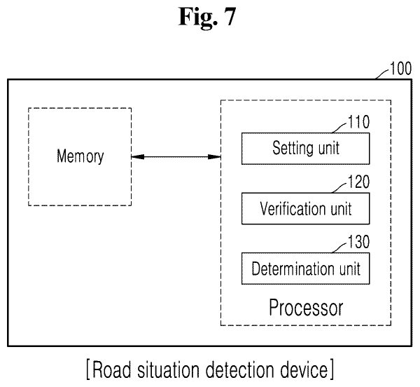

Hereinafter, a configuration of a road situation detection device 100 according to a third embodiment of the present disclosure will be described in detail with reference to FIG. 7.

As illustrated in FIG. 7, the road situation detection device 100 according to the third embodiment of the present disclosure includes a memory including instructions, a processor configured to execute the instructions in the memory. In particular, the processor may include a setting unit 170, a verification unit 173, and a determination unit 176 as functional elements implemented through the execution of the instructions.

The road situation detection device 100 according to an embodiment of the present disclosure may more accurately determine an abnormal situation regarding the driving of a vehicle object through the above-described functional elements 170, 173, and 176 of the process even when the shooting angle of a captured image is changed.

The setting unit 170 is responsible for setting the driving direction attribute.

More specifically, the setting unit 170 may set a driving direction attribute of a vehicle object with respect to a road region in a captured image.

In this case, the setting unit 170 may set the driving direction attribute with respect to the road region by using the recognition results of road facility objects installed along the road region in the captured image.

Here, the road facility objects refer to facilities (e.g., signposts, guide lights, traffic lights) for providing road-related information to a driver. These facilities must be visible to the driver and, therefore, are closely related to the driving direction of a vehicle.

Accordingly, the setting portion 170 may determine the driving direction of the vehicle object in the captured image from the installation state (e.g., installation direction and installation angle) of the road facility objects installed along the road region in the captured image.

Eventually, based on the result of the determination using the installation state of the road facility objects, the setting unit 170 sets at least one driving direction attribute, either a forward-driving attribute or a reverse-driving attribute, in a relative direction according to the shooting angle of the captured image with respect to the road region.

The verification unit 173 is responsible for verifying the reliability of a driving direction attribute that is set for a road region.

More specifically, when a driving direction attribute is set for a road region, the verification unit 173 may verify the reliability of the set driving direction attribute.

In this case, the verification unit 173 may verify the reliability of the driving direction attribute, which has been set for the road region, by using the degree of matching between a training value of a vehicle object trained from a viewpoint matched with the driving direction attribute, and a vehicle object recognized from the road region.

In other words, the verification unit 173 may determine that the reliability of the driving direction attribute set for the road region has been verified if the degree of matching between the training value of the vehicle object trained from the viewpoint matched with the driving direction attribute, and a vehicle object recognized in real time from the road region exceeds a threshold value.

Here, a training value of a vehicle object trained from a viewpoint matched with a driving direction attribute, may be understood as a visual form of the vehicle object that enables the determination of the driving direction (e.g., forward driving or wrong-way driving) of the vehicle object from the same viewpoint as the driving direction attribute.

Furthermore, the degree of matching exceeding the threshold value may be understood as a situation in which the percentage of vehicle objects matching the training values among vehicle objects recognized in real time from the road region is greater than or equal to a certain percentage.

The determination unit 176 is responsible for determining an abnormal situation regarding the driving of a vehicle object.

More specifically, when the reliability of a driving direction attribute set for a road region is verified, the determination unit 176 determines an abnormal situation regarding the driving situation of a vehicle object, based on the driving direction attribute having the verified reliability.

In this case, the determination unit 176 may determine an abnormal situation regarding the driving of a vehicle object by using a training value of the vehicle object trained from a relative viewpoint according to the shooting angle of a captured image.

Here, a training value of a vehicle object trained from a relative viewpoint according to the shooting angle of a captured image, may be understood to be the visual form of the vehicle object which enables the determination of the driving direction (e.g., forward driving or wrong-way driving) of the vehicle object from various viewpoints according to the shooting angle.

Eventually, the determination unit 176 uses a training value of a vehicle object trained from a relative viewpoint according to the shooting angle of a captured image, and thus determines that a case where a vehicle object driving in the reverse direction is recognized in a road region with a forward-driving attribute or where a vehicle object driving in the forward direction is recognized in a road region with a reverse-driving attribute is an abnormal situation regarding the driving of the vehicle object.

As described above, it may be seen that the road situation detection device 100 of the present disclosure sets a driving direction attribute in a relative direction according to a shooting angle for a road region in a captured image, and performs object recognition considering the set driving direction attribute, thereby enabling more accurate determination of abnormal situations, such as wrong-way driving of a vehicle object, even when the shooting angle of the captured image is changed.

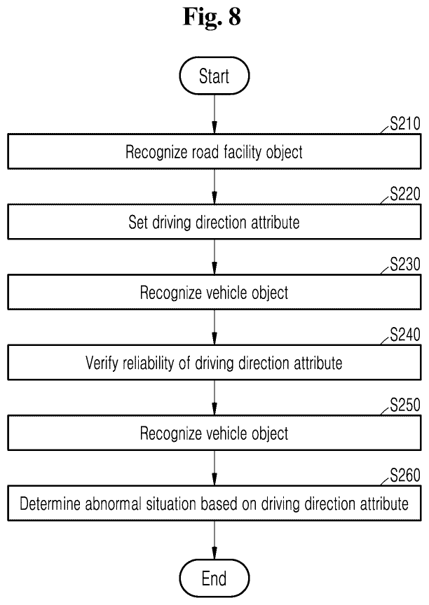

Hereinafter, a method for determining an abnormal situation according to a third embodiment of the present disclosure will be described with reference to FIG. 8.

For ease of description, the following description will refer to the road situation detection device 100, described with reference to FIG. 7, as an entity responsible for performing the abnormal situation determination method.

The road situation detection device 100 sets a driving direction attribute of a vehicle object with respect to a road region in a captured image (S210-S220).

In this case, the road situation detection device 100 may set the driving direction attribute with respect to the road region by using the recognition results of road facility objects installed along the road region in the captured image.

Here, the road facility objects refer to facilities (e.g., signposts, guide lights, or traffic lights) for providing road-related information to a driver. These facilities must be visible to the driver and, therefore, are closely related to the driving direction of a vehicle.

Accordingly, the road situation detection device 100 may determine the driving direction of the vehicle object in the captured image from the installation state (e.g., installation direction and installation angle) of the road facility objects installed along the road region in the captured image.

Eventually, based on the result of the determination using the installation state of the road facility objects, the road situation detection device 100 sets at least one driving direction attribute, either a forward-driving attribute or a reverse-driving attribute, in a relative direction according to the shooting angle of the captured image with respect to the road region.

Subsequently, when a driving direction attribute is set for the road region, the road situation detection device 100 verifies the reliability of the set driving direction attribute (S1230-S240).

In this case, the road situation detection device 100 may verify the reliability of the driving direction attribute, which has been set for the road region, by using the degree of matching between a training value of a vehicle object trained from a viewpoint matched with the driving direction attribute, and a vehicle object recognized from the road region.

In other words, the road situation detection device 100 may determine that the reliability of the driving direction attribute set for the road region has been verified if the degree of matching between the training value of the vehicle object trained from the viewpoint matched with the driving direction attribute, and a vehicle object recognized in real time from the road region exceeds a threshold value.

Here, a training value of a vehicle object trained from a viewpoint matched with a driving direction attribute, may be understood as a visual form of the vehicle object that enables the determination of the driving direction (e.g., forward driving or wrong-way driving) of the vehicle object from the same viewpoint as the driving direction attribute.

Furthermore, the degree of matching exceeding the threshold value may be understood as a situation in which the percentage of vehicle objects matching the training values among vehicle objects recognized in real time from the road region is greater than or equal to a certain percentage.

Subsequently, when the reliability of a driving direction attribute set for a road region is verified, the road situation detection device 100 determines an abnormal situation regarding the driving situation of a vehicle object, based on the driving direction attribute having the verified reliability (S250-S260).

In this case, the road situation detection device 100 may determine an abnormal situation regarding the driving of a vehicle object by using a training value of the vehicle object trained from a relative viewpoint according to the shooting angle of a captured image.

Here, a training value of a vehicle object trained from a relative viewpoint according to the shooting angle of a captured image, may be understood to be the visual form of the vehicle object which enables the determination of the driving direction (e.g., forward driving or wrong-way driving) of the vehicle object from various viewpoints according to the shooting angle.

Eventually, the road situation detection device 100 uses a training value of a vehicle object trained from a relative viewpoint according to the shooting angle of a captured image, and thus determines that a case where a vehicle object driving in the reverse direction is recognized in a road region with a forward-driving attribute or where a vehicle object driving in the forward direction is recognized in a road region with a reverse-driving attribute is an abnormal situation regarding the driving of the vehicle object.

As described above, according to the method for determining an abnormal situation according to the third embodiment of the present disclosure, by setting a driving direction attribute in a relative direction according to a shooting angle for a road region in a captured image, and performing object recognition considering the set driving direction attribute, an abnormal situation such as wrong-way driving of a vehicle object may be more accurately determined even when the shooting angle of the captured image is changed.

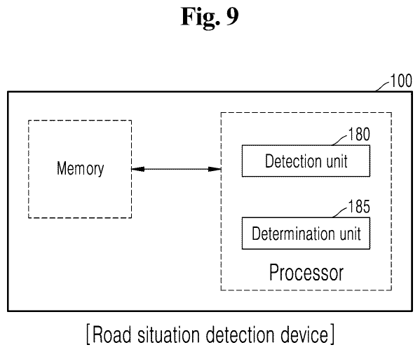

Hereinafter, a configuration of a road situation detection device 100 according to a fourth embodiment of the present disclosure will be described in detail with reference to FIG. 9.

As illustrated in FIG. 9, the road situation detection device 100 according to the fourth embodiment of the present disclosure may include a memory including instructions, and a processor configured to execute the instructions in the memory. In particular, the processor may include a detection unit 180 and a determination unit 185 as functional elements implemented through the execution of the instructions.

The road situation detection device 100 according to the fourth embodiment of the present disclosure may efficiently determine an abnormal situation regarding the driving of a vehicle object through the aforementioned functional elements 180 and 185 of the processor by using the type of color identified from a vehicle object region in a captured image.

The detection unit 180 is responsible for detecting the vehicle object region.

More specifically, the detection unit 180 may detect a vehicle object region, which is a region in which a vehicle object is present, from a captured image of a road section.

In this case, the detection unit 180 may detect the vehicle object region based on a luminance difference identified between adjacent regions in the captured image.

In other words, the detection unit 180 may detect, as a vehicle object region, a region that exhibits a higher luminance than an adjacent region in the captured image.

Using the luminance difference between regions in detecting a vehicle object region is for the purpose of utilizing regional characteristics in which a vehicle object region in a captured image has a relatively higher luminance than surround regions due to the light emitted by headlights, side marker lights, and taillights.

More specifically, the detection unit 180 sets a reference luminance difference as a reference value of the luminance difference between regions in a captured image, and based on the reference luminance difference, detects a region in the captured image, which has a higher luminance than an adjacent region by at least the reference luminance difference, as a vehicle object region.

The reference luminance difference, set as a reference value for detecting a vehicle object region, may be set to a different value depending on the change in ambient illumination in a road section where an image is captured.

In this regard, the detector 180 may set the reference luminance difference to a larger luminance difference value as the ambient illumination in the road section where the image is captured decreases.

For example, during nighttime when the illumination in a road section where an image is captured is low, the luminance of a vehicle object region will be more pronounced compared to the surrounding region, so the reference luminance difference may be set to a high value. Conversely, during daytime when the illumination is high, the luminance of the vehicle object region becomes similar to the luminance of the surrounding region compared to nighttime, so the reference luminance difference may be set to a low value.

As a result, in an embodiment of the present disclosure, the reference value for detecting a vehicle object region in a road section where an image is captured may be set to an adaptive value that takes into account the effect of ambient illumination, thereby increasing the reliability of a vehicle object region detection result.

The determination unit 185 is responsible for determining an abnormal situation regarding the driving of a vehicle object.

More specifically, when a vehicle object region is detected from a captured image, the determination unit 185 identifies the detected vehicle object region to determine an abnormal situation regarding the driving of a vehicle object.

In this case, the determination unit 185 may determine a wrong-way driving situation of the vehicle object as an abnormal situation regarding the driving of the vehicle object by using the type of color identified from the vehicle object region.

In this regard, from the vehicle object region, the determination unit 185 identifies the red color, which is the rear color characteristic of the vehicle object, or identifies the white and orange colors, which are the front color characteristics of the vehicle object.

Here, the red color, which is the rear color characteristic of the vehicle object, may be understood as the color of taillights of the vehicle object, and the white and orange colors, which are the front color characteristics of the vehicle object, may be understood as the colors of headlights and side marker lights of the vehicle object.

The determination unit 185 determines, using the color characteristics of the vehicle object identified in this way, that a case in which the type of color opposite to a driving direction attribute set as a forward or reverse direction for the road section is identified from a vehicle object region is an abnormal situation which is a wrong-way driving situation of the vehicle object.

For example, when the red color, which is the rear color characteristic of a vehicle object, is identified from a vehicle object region in a road section where a forward driving direction attribute is set, or conversely, when the white and orange colors, which are the front color characteristics of the vehicle object, are identified from a vehicle object region in a road section where a reverse driving direction attribute is set, the situation may be determined as an abnormal situation which is wrong-way driving of the vehicle object.

Furthermore, the determination unit 185 determines that a case in which a color different from that of other vehicle object regions within a captured image is identified from a vehicle object region is an abnormal situation, which is a wrong-way driving situation of the vehicle object.

For example, when the white and orange colors, which are front color characteristics of a vehicle object, are identified from a vehicle object region, while the red color, which is rear color characteristic of vehicle objects, is identified from other vehicle object regions in a captured image, or conversely, the red color, which is a rear color characteristic of a vehicle object, is identified from a vehicle object region, while the white and orange colors, which are front color characteristics of vehicle objects, are identified from other vehicle object regions in the captured image, this situation may be determined to be an abnormal situation which is a wrong-way driving situation of the vehicle object.

As described above, it can be seen that the road situation detection device 100 of the present disclosure detects a vehicle object region based on a luminance difference between regions in a captured image, and determines an abnormal situation regarding the driving of a vehicle object by using the type of color identified from the detected vehicle object region, thereby making it possible to more accurately determine an abnormal situation such as wrong-way driving of the vehicle object even during nighttime when it is difficult to identify the vehicle object.

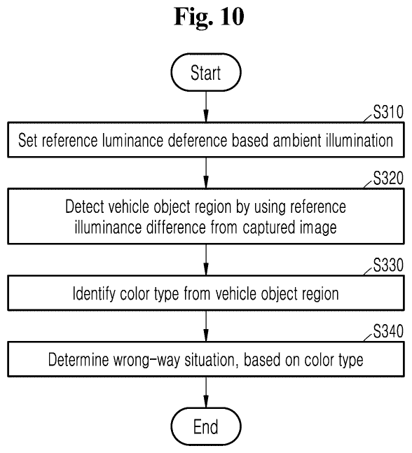

Hereinafter, a method for determining an abnormal situation according to the fourth embodiment of the present disclosure will be described with reference to FIG. 10.

For ease of description, the following description will refer to the road situation detection device 100, described with reference to FIG. 9, as an entity responsible for performing the abnormal situation determination method.

The road situation detection device 100 may detect a vehicle object region, which is a region in which a vehicle object is present, from a captured image of a road section (S310-S320).

In this case, the road situation detection device 100 may detect the vehicle object region based on a luminance difference identified between adjacent regions in the captured image.

In other words, the road situation detection device 100 may detect, as a vehicle object region, a region that exhibits a higher luminance than an adjacent region in the captured image.

Using the luminance difference between regions in detecting a vehicle object region is for the purpose of utilizing regional characteristics in which a vehicle object region in a captured image has a relatively higher luminance than surround regions due to the light emitted by headlights, side marker lights, and taillights.

More specifically, the road situation detection device 100 sets a reference luminance difference as a reference value of the luminance difference between regions in a captured image, and based on the reference luminance difference, detects a region in the captured image, which has a higher luminance than an adjacent region by at least the reference luminance difference, as a vehicle object region.

The reference luminance difference, set as a reference value for detecting a vehicle object region, may be set to a different value depending on the change in ambient illumination in a road section where an image is captured.

In this regard, the road situation detection device 100 may set the reference luminance difference to a larger luminance difference value as the ambient illumination in the road section where the image is captured decreases.

For example, during nighttime when the illumination in a road section where an image is captured is low, the luminance of a vehicle object region will be more pronounced compared to the surrounding region, so the reference luminance difference may be set to a high value. Conversely, during daytime when the illumination is high, the luminance of the vehicle object region becomes similar to the luminance of the surrounding region compared to nighttime, so the reference luminance difference may be set to a low value.

As a result, in an embodiment of the present disclosure, the reference value for detecting a vehicle object region in a road section where an image is captured may be set to an adaptive value that takes into account the effect of ambient illumination, thereby increasing the reliability of a vehicle object region detection result.

Subsequently, when a vehicle object region is detected from a captured image, the road situation detection device 100 identifies the detected vehicle object region to determine an abnormal situation regarding the driving of a vehicle object (S330-S340).

In this case, the road situation detection device 100 may determine a wrong-way driving situation of the vehicle object as an abnormal situation regarding the driving of the vehicle object by using the type of color identified from the vehicle object region.

In this regard, from the vehicle object region, the road situation detection device 100 identifies the red color, which is the rear color characteristic of the vehicle object, or identifies the white and orange colors, which are the front color characteristics of the vehicle object.

Here, the red color, which is the rear color characteristic of the vehicle object, may be understood as the color of taillights of the vehicle object, and the white and orange colors, which are the front color characteristics of the vehicle object, may be understood as the colors of headlights and side marker lights of the vehicle object.

The road situation detection device 100 determines, using the color characteristics of the vehicle object identified in this way, that a case in which the type of color opposite to a driving direction attribute set as a forward or reverse direction for the road section is identified from a vehicle object region is an abnormal situation which is a wrong-way driving situation of the vehicle object.

For example, if the red color, which is the rear color characteristic of a vehicle object, is identified from a vehicle object region in a road section where a forward driving direction attribute is set, or if the white and orange colors, which are the front color characteristics of the vehicle object, are identified from a vehicle object region in a road section where a reverse driving direction attribute is set, the situation may be determined as an abnormal situation which is wrong-way driving of the vehicle object.

Furthermore, the road situation detection device 100 determines that a case in which a color different from that of other vehicle object regions within a captured image is identified from a vehicle object region is an abnormal situation, which is a wrong-way driving situation of the vehicle object.

For example, when the white and orange colors, which are front color characteristics of a vehicle object, are identified from a vehicle object region, while the red color, which is rear color characteristic of vehicle objects, is identified from other vehicle object regions in a captured image, or conversely, the red color, which is a rear color characteristic of a vehicle object, is identified from a vehicle object region, while the white and orange colors, which are front color characteristics of vehicle objects, are identified from other vehicle object regions in the captured image, this situation may be determined to be an abnormal situation which is a wrong-way driving situation of the vehicle object.

As described above, according to the abnormal situation determination method according to the fourth embodiment of the present disclosure, by detecting a vehicle object region based on a difference in luminance between regions in a captured image, and determining an abnormal situation regarding the driving of a vehicle object by using the type of color identified from the detected vehicle object region, an abnormal situation such as wrong-way driving of the vehicle object may be more accurately determined even during nighttime when it is difficult to identify the vehicle object.

Meanwhile, the realized articles of functional operations and subject matters described in this specification can be implemented using digital electronic circuits, or implemented as computer software, firmware, or hardware including the configuration disclosed in this specification and structural equivalents thereof, or as a combination be at least one of these implementations. The articles of realization of the subject matter described in this specification can be implemented as one or more computer program product, that is, one or more module related to computer program instructions which are encoded on a tangible program storage medium for controlling the operation of the process system or for being executed by the same.

The computer-readable medium can be a machine-readable storage device, a machine-readable storage board, a memory device, a composition of materials affecting machine-readable wave signals, and a combination of at least one of them.

The term such as “a system” or “a device” in this specification encompasses all tools, devices, and machines for processing data including, for example, a programmable processor, a computer, or a multi-processor. The process system can include a code for creating an execution atmosphere for the computer program, when requested by a code constituting a processor firmware, a protocol stack, a database management system, an operating system, or a combination of at least one of them, etc., in addition to a hardware.

The computer (also known as a program, a software, a software application, a script, or a code) can be created in all types of program languages including a compiled or interpreted language or a priori or procedural language, and can be arranged in all types including standalone programs, modules, subroutines, and other units proper to be used in a computing environment. The computer program does not necessarily correspond to a file of a file system. The program can be stored in a single file provided by the requested program, in multiple files which interact with each other (for example, files storing one or more module, low level programs or some of the code), or in a part of the file containing other programs or data (for example, one or more script stored in a markup language document). The computer program can be arranged to be positioned in one site or distributed over a plurality of sites, such that it can be executed on multiple computers interconnected via a communication network or on a single computer.

Meanwhile, the computer-readable medium which is proper for storing computer program instructions and data can include and all types of nonvolatile memories, media, and memory devices including a semiconductor memory device such as EPROM, EEPROM and flash memory device, a magnetic disk such as internal hard disk or removable disk, optical disk, a CD-ROM and a DVD-ROM disk. The processor and the memory can be supplemented by a special purpose logic circuit or integrated into the same.

The article of realization of the subject matter described in this specification can include a back-end component such as a data server, a middleware component such as an application server, or a front-end component such as a client computer having a web browser or a graphic user interface which enables a user to interact with the article of realization of the subject matter described in this specification, or can implement all combinations of these back-end, middleware, or front-end components in a computing system. The components of a system can be interconnected with each other by all types or media of digital data communication such as a communication network.

Although this specification includes details of various specific implementations, it is not to be understood as limiting for all inventions or scope to be claimed, and it should rather be understood as an explanation for the features which can be unique to specific implementations of the specific invention. Similarly, the specific features described in this specification in the context of separate implementations can be implemented to be combined in a single implementation. On the contrary, various features described in the context of the single implementation can also be implemented as discrete or proper low level combinations as well as in various implementations. Furthermore, although the features can be depicted as work in a specific combination and as claimed in the first place, one or more features from the claimed combination can be excluded from the combination in some cases, and the claimed combination can be changed to the low level combinations or subcombinations.

Also, although this specification depicts the operations in a specific order in the drawings, it is not to be understood that this specific sequence or order should be maintained or all the shown operations should be performed in order to obtain the preferred results In specific cases, multitasking and parallel processing can be preferable. Also, the division of various system components of the aforementioned embodiments are not to be construed as being required by all embodiments, and it is to be understood that the described program components and systems can generally be unified into a single software product or packaged in multiple software products.

Similarly, this specification is not intended to limit the present invention to specific terms provided. Therefore, although the present invention has been explained in detail by referring to the aforementioned examples, it is possible for the person having ordinary skill in the art to alter, change, or modify these examples without departing from the scope of the present invention. The scope of the present invention is expressed by the claims, not by the specification, and all changes and modified shapes derived from the meanings of the claims, scopes, and the equivalents thereof are construed to be included in the scope of the present invention.

1. A road situation detection device comprising:
a memory comprising instructions; and
a processor configured to, by executing the instructions, determine an abnormal situation of vehicle driving for both daytime and nighttime captured images by using an abnormal situation determination model configured to determine an abnormal situation regarding driving of a vehicle in a road region by learning a daytime captured image.

2. The road situation detection device of claim 1, wherein the processor is configured to input data predicted and processed based on vehicle lights recognized in a nighttime captured image of an object to be determined into an abnormal situation determination model, and to acquire a determination result of an abnormal driving situation in the nighttime captured image from the abnormal situation determination model.

3. The road situation detection device of claim 2, wherein the predicted and processed input data comprise predicted vehicle object attributes and processed driving feature information associated with the vehicle lights, and
wherein the processor is configured to:
predict vehicle object attributes, which are mapped to vehicle lights recognized in the nighttime captured image, based on shapes of the lights, sizes of the lights, distances between the lights, or whether the lights are front or rear lights; and
reflect a bounding box according to the predicted vehicle object attributes in a movement path of the vehicle lights recognized in the nighttime captured image, process the bounding box as a vehicle object corresponding to each of the vehicle lights, and produce driving feature information regarding the bounding box.

4. The road situation detection device of claim 3, wherein the driving feature information regarding the bounding box comprises driving speed, driving acceleration, driving angle, and angular velocity, and
wherein the determination result from the abnormal situation determination model comprises at least one among vehicle speeding, reverse driving, abnormal driving, and abnormal stopping.

5. The road situation detection device of claim 2, wherein the processor is configured to, when a determination result of an abnormal driving situation in a nighttime captured image is acquired using the abnormal situation determination model, use the determination result in case that acquisition of the same determination result is maintained even after elapse of a determination waiting time that varies in inverse proportion to a reliability score of the predicted and processed input data.

6. The road situation detection device of claim 5, wherein the reliability score rises as the degree of mapping between the vehicle lights and the vehicle object attributes increases during prediction of the vehicle object attributes, and as the accuracy of selection of the bounding box according to the predicted vehicle object attributes increases in reflecting the bounding box and processing the bounding box as a vehicle object corresponding to each of the vehicle lights.

7-15. (canceled)
